(19) United States
(12) Patent Application Publication
(10) Pub. No.: US 2004/0133503 A1
(43) Pub. Date: Jul. 8, 2004

(54) Method and system for auctioning shares of an investment product

(76) Inventor: Eugene L. Podsiadlo, Princeton, NJ (US)

Correspondence Address: Ian G. DiBernardo, Stroock & Stroock & Lavan LLP, 180 Maiden Lane, New York, NY, 10038, US

(21) Appl. No.: 10/729,483

(22) Filed: Dec. 5, 2003

Related U.S. Application Data
(63) Continuation-in-part of application No. 09/668,547, filed on Sep. 25, 2000.
(60) Provisional application No. 60/431,098, filed on Dec. 5, 2002.

(51) Int. Cl. G06F 17/60

(52) U.S. Cl. 705/37

(57) ABSTRACT

A communication network based system and method for auctioning shares of an fund is disclosed. In one embodiment, the fund is an investment company or fund registered under the Investment Company Act of 1940, as amended, and capital is provided by the sponsor or an affiliate as sole shareholder. After the fund returns a pre-determined launch rate, or rate of return, the fund then preferably sells its positions and purchases money market instruments in order to freeze the NAV of the shares of the fund. The fund is later opened for auction and the server system receives and stores bids from a plurality of bidders, in increments up to the NAV. The bids preferably comprise a bid price per share and the number of shares bid. At the close of the auction, the server system preferably determines successful bidders by successively determining the highest bidder. During this process, the server system reduces the total number of available shares to be distributed by the number of shares bid by the highest bidder. Once all of the available shares have been allocated to the successful bidders, the fund shares are redeemed at the net asset value (NAV) reflecting the launch rate. Each of the successful bidders is receives a return equal to the difference between the NAV and the respective successful bidders' bid price per share multiplied by the number of shares bid by each respective successful bidders.

### CROSS REFERENCE TO RELATED APPLICATIONS

The present application is a continuation-in-part of U.S. patent application Ser. No. 09/668,547, filed Sep. 29, 2000, entitled COMMUNICATION NETWORK BASED SYSTEM AND METHOD FOR AUCTIONING SHARES OF AN FUND, and claims the benefit of U.S. Provisional Application Serial No. 60/431,098, filed Dec. 5, 2002, entitled METHOD AND SYSTEM FOR AUCTIONING SHARES OF AN FUNDS, both of which are hereby incorporated herein by reference

### BACKGROUND OF THE INVENTION

1. Field of the Invention

The present invention generally relates to the field of funds, including, but not limited to, investment companies, and to the field of conducting auctions, including, but not limited to, auctions over a communications network, such as the Internet. More particularly, the present invention relates to a system and method for auctioning shares of a fund that periodically declares a net asset value (“NAV”) per share or unit. Such products (as used herein, “funds”) include funds, including, without limitation, vehicles known as closed-end investment companies and open-end investment companies which are registered under the Investment Company Act of 1940, as amended (the “1940 Act”).

2. Description of Related Art

A fund is a pooled collection of stocks, bonds, other securities and/or financial instruments managed by a professional investment adviser. Some benefits of investing in a fund include professional investment management, diversification of risks through a variety of investments and economies of scale. Investors achieve returns of the investments in the fund in two ways: (1) by receiving income generated by the investments of the fund; and (2) by sharing in the net appreciation of the investments of the fund. With over $7 trillion in assets today, funds are a well-respected vehicle that form the basis of financial planning for many investors. A fund, like many funds, provides exposure to market and investment risk. That is, investors still bear the risk that their investments may not achieve a desired expected return and that their fund shares may decrease in value.

Shares in open-end investment companies funds are sold at NAV to investors. The NAV is the unit price per share and is determined by dividing the total assets of the fund, minus its expenses and liabilities, by the total number of shares outstanding. In contrast, while closed-end investment companies have an NAV, their share purchase price is usually a market price determined through the pressures of supply and demand. In either case, the NAV of a fund will, by definition, fluctuate in response to the value of its underlying investments. The prospective investment return at the time of investment is unknown; the subsequent sales price for fund shares may be higher, lower, or equal to the original purchase price.

It would be desirable to have a system and method of auctioning shares of a fund wherein investors may achieve investment returns on their investment by knowing in advance what the subsequent sales price of the shares of the fund will be as of a particular forward date, and buying shares at a discount to that forward sales price through an auction process.

Communications network based systems and methods for conducting auctions of items are known in the art. In such systems, bidders, via a bidder computer, are able to communicate with a server computer over a communications network, such as the Internet. Residing on the server computer is a web site. A bidder, via a bidder computer, is able to access the web site, view information about the items open for auction, and submit bids on the items.

However, such existing systems and methods fail to adequately provide for the auctioning of shares in a fund. More specifically, a need exists for a system and method for auctioning shares of an fund whose sales price can be determined at a forward date or otherwise specified. A further need exists for a system and method for auctioning shares of such an fund wherein investors may eliminate most of their investment risk by purchasing a portion of the returns already generated by the investment adviser and bid freely and anonymously among an investor population for those returns.

### SUMMARY OF THE INVENTION

The present invention relates to a system and method for auctioning shares of an fund, such as an investment company registered under the 1940 Act or other fund and satisfies the foregoing and other needs. Preferably (i.e., not required), the entity comprising the fund for auction is an investment company registered under the 1940 Act. Preferably, the fund has a subsequent sales price that can be determined at a forward date or otherwise specified.

In one embodiment, an investment company is created and seeded with capital. The fund's assets are actively managed with the goal of obtaining a pre-determined launch rate, or rate of return. Once this return has been achieved and is reflected in the NAV of shares of the fund, the fund sells its positions and purchases money market instruments (e.g., short-term U.S. Treasury bills) or other cash equivalents in order to maintain or “lock-in” the return. As a result, a temporary “freeze” occurs in the NAV of the shares of the fund because the securities in the fund have minimal downside risk in the form of either market or credit risk.

In accordance with an embodiment of the invention, the fund's shares are offered for sale in a secondary on-line auction where bidders pre-register for the auction by establishing a money market fund or other companion investment account with the fund sponsor. If desired, each bidder who qualifies for participation in the auction process can maintain anonymity by establishing a User ID in the registration process. The on-line auction is administered by a server system that includes a web site that bidders may access remotely via a communications network, such as the Internet. The web site provides information about the funds that are open for auction and receives bids on the shares of those funds at a discount to the current NAV. At the conclusion of the auction, the shares of the fund are redeemed at the current NAV, thereby providing a gain to the successful bidders. Preferably, this process can be implemented in multiple methods, including, but not limited to, a fund termination provision or redemption provision contained in prospectus disclosure, in compliance with the 1940 Act.

One embodiment of the present invention relates to a method of conducting an auction for shares of a fund that periodically declares an NAV comprising the steps of: a) receiving at the server system information relating to the fund, the fund having achieved a launch rate, the fund information including a total number of available shares and the NAV, the NAV corresponding to the share price of the fund at the launch rate; b) storing at the server system the fund information; c) opening an auction for the shares of the fund; d) receiving from bidder computers during the auction bids relating to the fund, the bids preferably including a bid price per share and the number of shares bid; e) storing the bids on the server system; f) (i) determining a successful bidders, (ii) updating the fund information by reducing the number of available shares by the number of shares bid by the successful bidder and (iii) repeating steps (i) and (ii) until no available shares remain.

According to another embodiment of, the present invention relates to a system for auctioning shares of a fund that periodically declares an NAV comprising: a web site accessible via the communications network; means for receiving information relating to the fund, the fund having achieved a launch rate, the fund information including a total number of available shares and the NAV, the NAV corresponding to the share price of the fund at the launch rate; means for storing the fund information; means for opening an auction relating to the shares of the fund; means for receiving during the auction bids from bidder computers, the bids including a bid price per share and a number of shares bid; means for storing the bids; means for successively determining a successful bidder; and means for successively updating the fund information by reducing the total number of available shares by the number of shares bid by the successful bidder until of all the available shares have been allocated.

The advantages of the embodiments described herein are numerous. First, everyday investors can transfer most of their own investment risk to a professional trading firm, investment bank, or other asset manager who can produce investment returns in a format, i.e., a fund, which can be freely auctioned to customers only after the risk has been taken and the return achieved by the professional asset manager. This is the reverse of the current available fund sales process in which consumers invest their money and are immediately exposed to investment risk with their own investment capital. As much as the customer is attracted to such a reversal of the risk process and willing to pay for the opportunity to bid on such fund shares, the sponsor of such a product is motivated to capture large investor assets in money market funds or other companion funds that serve both as settlement vehicles for the auction and which qualify customers to enter the auction(s).

Also, because bidders are able to bid on the NAV of the shares of an fund after a predetermined launch rate has been achieved, bidders are able to determine which bid will yield an acceptable return on their investments. Risk to the investor's investment principal is primarily limited to the opportunity cost of placing a hold on the investor's capital during the auction itself as unsuccessful bidders do not make any payment and successful bidders know in advance that the investment outcome of their bid will be mathematically positive.

In addition, the fund allows a customer to bid on, and potentially purchase shares that would be redeemed in cash following the close of the auction at a redemption price, or current NAV, identified at the beginning of the auction, and one which is higher than the customer paid to purchase the shares. For example, if a customer were able to bid on, and purchase, shares that would be redeemed at a price of $10.20, the customer might bid $10.15 per share during the auction. Accordingly, the return on a $25,000 investment would be the difference between the two prices ($10.20-$10.15) times the number of shares purchased ($25,000 divided by $10.15), or $123.15. This represents a simple return on investment of 0.49%. Alternatively, the customer might bid $10.00 per share for the same shares with a redemption value of $10.20 and receive a $500 gain on the shares, or a 1% simple return on investment. In this way, customers determine what an acceptable return on their investment is, subject to their assessment of how other bidders will bid for the same available shares.

Finally, because the auction takes place over a communications network in certain embodiments, the fund is able to achieve a larger market for its finds. Numerous bidders in a plurality of locations are able to participate in the auction simultaneously. A bidder only needs access to a communications network, such as the Internet. In addition, the auction process can be carried out over a much longer period of time than is traditionally possible, for example a period of days rather than hours. As such, customer participation during “off-hours” is possible.

These above features and advantages, as well as the many other features and advantages described below, are not all inclusive. Many additional features and advantages will be apparent to one of ordinary skill in the art in view of the drawings, detailed description, and claims hereof.

### BRIEF DESCRIPTION OF THE DRAWINGS

These and other objects, features and advantages of the invention are more fully set forth in the accompanying Detailed Description of the Invention in which:

FIG. 1 is a high-level diagram showing a server and a plurality of bidder computers interconnected via a communications network;

FIG. 2 is a high-level diagram of a preferred bidder computer system of the present invention;

FIG. 3 is a high-level diagram of a preferred server system of the present invention;

FIG. 4 is a flowchart showing a preferred general operation of the present invention;

FIG. 5 is a flowchart showing a preferred process of opening and closing an auction;

FIG. 6 is a flowchart showing a preferred process of receiving and storing bids;

FIG. 7 is an illustrative web home page;

FIG. 8 is an illustrative web page that allows a bidder to open an account;

FIG. 9 is an illustrative web page showing information about auctions that may be bid on;

FIG. 10 is an illustrative web page that allows the bidder to view his account balance and place bids on auctions;

FIG. 11 is a flowchart showing a preferred process of verifying bids;

FIG. 12 is a flowchart showing a preferred process of determining successful bidders;

FIG. 13 is a flowchart showing a preferred process of determining unsuccessful bidders;

FIG. 14 is an illustrative web page showing information about a past auction;

FIG. 15 depicts an illustration of a preferred dollar return on successful bids plot according to a highest bidder auction formula; and

FIG. 16 depicts an illustration of a preferred list of successful bids according to a highest bidder auction formula.

### DETAILED DESCRIPTION OF THE INVENTION

As discussed above, the present invention relates to a system and method for auctioning shares of a fund, whose NAV can be determined at a forward date or otherwise specified.

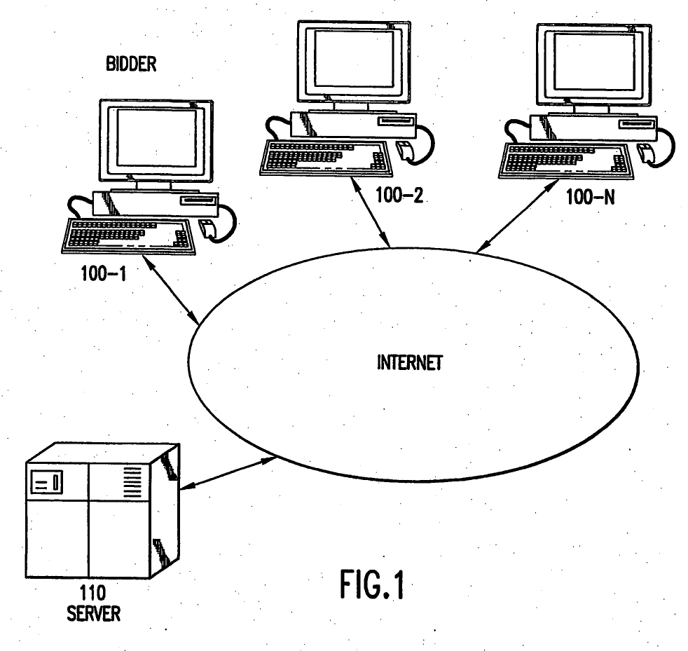

These auctions are preferably run by a server system that is accessible to bidders via a communications network. FIG. 1 depicts a high-level diagram of a server system 110 as connected to a plurality of bidder computer systems 100 via a communications network, such as the Internet.

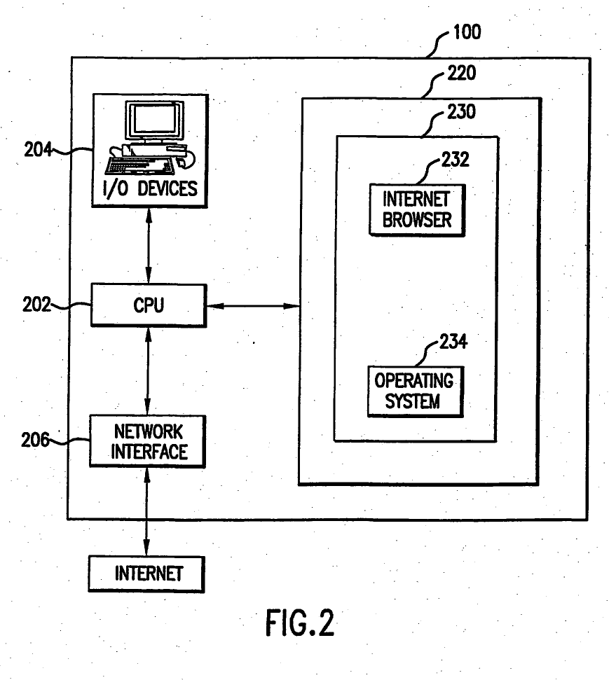

FIG. 2 depicts a high-level diagram of an illustrative bidder system 110. The bidder system may comprise any computer system that allows the bidder to access the server system. For example, and as is well known, bidder system 100 may be a programmed general purpose computer that includes a processor 202; memory 220; I/O devices 204 such as a monitor, a mouse, and a keyboard; and a communications network interface 206 that allows the computer to access the server system.

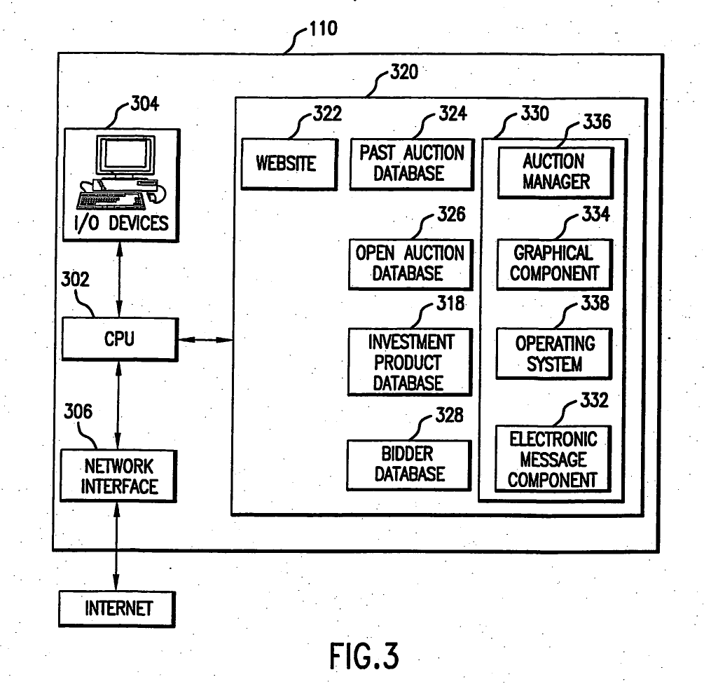

FIG. 3 depicts a high-level diagram of a preferred server system 110 of the present invention. As is shown, the server system 110 may be a general purpose computer that includes a processor 302, memory 320, and a system web site 322 that is accessible via the Internet. The server system 110 memory preferably includes: (1) a bidder database 328, (2) an fund database 318, (3) an open auction database 326, (4) a past auction database 324, and (5) computer programs 330 that allow server system 110 to operate in accordance with the invention. As is well known, some or all of the stored databases can be located apart from server system 110 and connected thereto by a communications network.

Bidder database 328 includes information about the bidders and, in the present embodiment, includes for each bidder information concerning:

(1) bidder name;

(2) bidder account information;

(3) available balance;

(4) bid information;

(5) bidder account history;

(6) bid control number; and

(7) bidder registration information.

Fund database 318 includes information about the funds for auction and, in the present embodiment, includes for each fund, information concerning:

(1) fund name;

(2) fund total market value;

(3) a total biddable return;

(4) a final or redemption share price;

(5) a maximum price per share;

(6) a minimum price per share;

(7) an auction opening time; and

(8) an auction closing time.

In one embodiment, the fund is a fund. In such an instance, a fund's total market value is preferably calculated by multiplying the number of shares of the fund by the market price per share. The total biddable return for the fund is preferably calculated by taking the difference between the total market value of the fund at liquidation or redemption (i.e., when it achieves its investment return launch rate) and the total market value of the fund at its inception, divided by the total number of shares of the fund.

In one embodiment, bids are made in increments of whole cents per share. The maximum bid price per share is one cent less than the redemption price, or current NAV, of the fund. The minimum bid price per share preferably is the purchase price per share paid upon creation of the fund, but can be any price less than the fund's current NAV, which is typically priced in dollars and whole cents for U.S. dollar-denominated funds.

In one embodiment, the auction opening and closing times are predetermined. The duration of the auction is typically 18-24 hours.

Open auction database 326 includes information concerning the auctions, and preferably includes for each such auction identification of the bidders and the bids they have made.

In one embodiment, the current highest bid during an auction may be periodically calculated by the server. If so, information concerning the current highest bid may also be stored in the open auction database.

Past auction database 324 includes information about auctions which have been completed, and in the present embodiment includes for each such auction, information concerning:

(1) fund name;

(2) number of bidders who participated in the auction;

(3) ratio of total shares bid to total shares available at auction;

(4) ratio of successful bidders to bidders;

(5) average dollar bid;

(6) biddable total return;

(7) fund total market value;

(8) the price per share at liquidation or redemption;

(9) shares available at auction;

(10) an auction opening time; and

(11) an auction closing time.

The auction manager 336 software component runs the fund auctions on the web site. In a preferred embodiment, the auction manager opens and closes the auctions, verifies and stores bids for the auctions, determines the winning and losing bidders, and calculates the other data relating to the auctions discussed herein.

The graphical component 334 may comprise any software that can create graphs and/or tables based on the data stored at server system 110. These graphs and tables may be requested by bidders at the web site 322.

The electronic message component 332 may comprise any software that transmits electronic messages to bidders over a communications network, such as the Internet. Electronic message component 332 also transmits bidder registration data and successful bidders information, such as the number of shares bid by each successful bidder, to the fund's transfer agent for the purpose of settling the successful transactions. Preferably, the transfer agent determines each successful bidder's ownership of the shares of the fund, thereby effectuating purchase of the shares before the shares are redeemed at the redemption price, or the current NAV.

Having described illustrative server and bidder systems, the operation of the auction process is now described. Although described in the context of a server-based system, the scope of the present invention includes implementing the process in any known way, including manually and semi-automated processes. For example, the taking of bids could be done in person, live, or over a telephone and manually entered into a written or electronic database. By way of further example, determination of the successful bidder(s) may be done in an automated fashion, using a computer, a manual fashion, or a combination thereof.

In one embodiment, a financial services company first creates an fund (e.g., a fund) which declares a daily or periodic single share price with itself as sole shareholder. After the fund returns a pre-determined launch rate, or rate of return, through the appreciation and/or sale of the underlying securities in the fund, the fund then preferably liquidates its investment positions and invests the proceeds in cash or cash equivalent instruments in order to freeze the NAV of the shares of the fund. As discussed above, the NAV, or unit price per share, is preferably calculated by dividing the total assets of the fund, minus its expenses and liabilities, by the total number of fund shares outstanding.

In the present embodiment the launch rate is positive. The auction process of the present invention, however, may be run for an fund that has achieved a negative rate of return since its inception. In this case, bidders preferably begin bidding at a purchase price less than the NAV.

The process by which the fund is created, reaches its predetermined launch rate, and is liquidated to freeze the NAV is unimportant to the present invention. This process may be automated, semi-automated, or simply performed manually by one or more employees or agents of the fund.

In any event, once the fund is available for auction, information relating to the fund is stored at server system 110. In a preferred embodiment, the following information about the fund is provided to the server: fund name, total market value, total biddable return, redemption price per share, maximum price per share, minimum price per share, and auction opening and closing times (i.e., the information that is preferably stored at fund database 318.)

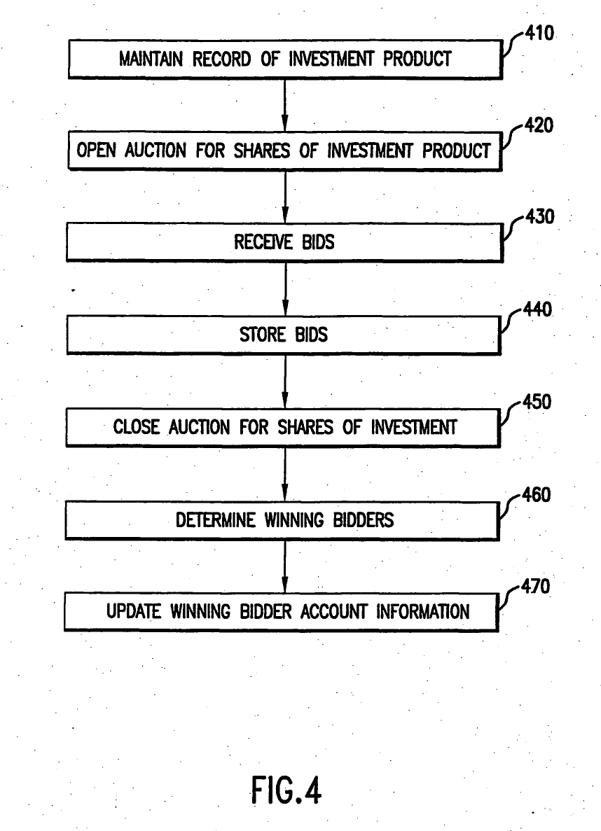

FIG. 4 is a flowchart depicting the general operation of the present embodiment once data describing a particular fund has been entered into server system 110. As illustrated by step 410, the fund data is received at server system 110. At some predetermined time, the shares of the fund are then opened for auction (step 420). During the auction, the server system 110 receives and stores (steps 430 and 440) the bids made for the shares. In a preferred embodiment, these bids include a bid price per share and the number of shares bid.

In step 450, the auction for the shares of the fund is closed. The server then determines the successful bidders (step 460) according to one or more auction method formulas, examples of which are described below.

In one embodiment, for example, the server successively determines the successful bidder by determining the bidder with the highest price per share bid. If there is more than one bidder with the highest bid price per share, then the successful bidder is the bidder who bid the highest number of shares bid. If there is more than one bidder with the highest bid price per share and the highest number of shares bid, then the successful bidder is the bidder who bid earlier in time. The server reduces the number of shares in the fund to be distributed by the number of shares bid by the successful bidder and allocates them to the successful bidder. The server then determines the next successful bidder among the bidders who have not been allocated shares and reduces the number of shares in the fund to be distributed by the number of shares allocated to the next successful bidder, and so on, until all of the available shares have been allocated. In the highest bid formula described here, earliest time of bid determines the successful bidder if multiple bids are received at the same price and if the last shares to be allocated are at a price for which there are multiple bidders.

Finally, in step 470, the server updates the bidder account information for the successful bidders to reflect a purchase of the number of shares bid and a return according to whatever auction method is utilized. In a preferred embodiment, the return for each successful bidder is the difference between the current NAV share price and the successful bidders's share price bid multiplied by the number of shares bid. Preferably, the current NAV is the redemption price of the shares after the auction is complete.

Certain exemplary processes for performing the steps of FIG. 4 are now described.

Although the foregoing embodiment determined the successful bid by the highest price per share bid, other manners of determining the successful bid are within the scope of the present invention.

More specifically, the successful bidders may be determined in one round of bidding or in multiple rounds, and the bids may be confidential or public. There are several manners in which the successful bidders may be determined in one round. The successful bidders may be determined in a discriminatory manner. Examples of discriminatory criteria can include price, in which case the highest price bidders would win; time, in which case the earliest-placed bidders would win; or both price and time, in which case the highest and earliest bidders would win.

The concept of uniform pricing can also be applied to determine the successful bidders in one round. A clearing price (i.e., single price that all bidders pay) can be established. The clearing price can be determined in a variety of different ways. In certain embodiments, the clearing price is the highest losing bid or the lowest winning bid. For example, where the highest bid prevails, the second highest bid is the clearing price.

Random selection methods can also be used to determine the successful bidders in one round. A simple random drawing can select a successful bidder at random from all the bidders or from a class of bidders. For example, the class of bidders may, but does not have to, be predetermined to include all bidders that bid the same price or that bid within a certain price range. Random selection can also be applied in an alternating manner among two or more classes of bidders, where a successful bidder is randomly selected from one class and then a successful bidder is randomly selected from another class, repeating the process until all the shares are allocated. Random selection among two or more classes of bidders with members of a class having priority based on some criteria can also be used to determine successful bidder, including, for example, random selection of either odd or even bid prices as winners, with earliest placed bids receiving priority until all shares allocated.

Other embodiments applying a random selection utilize a weighted random drawing where each bidder is assigned a selection probability weight to select successful bidders. The probability weight (p) may, but does not have to, be defined as p=Bid Price−Based Bid Price (e.g., 1 cent less than the lowest allowable bid). According to such formula, higher bids have a relatively higher probability (p) of being selected. Such probability weight need not give precise odds. The probability weight may also be defined according to one or more other criteria or combination of criteria. For example, in certain embodiments the probability depends on the amount bid, for example, so the probability is proportional to the bid (e.g., proportional to bid in relation to the range of bids, or indirectly proportional; for example, 1/5 probability weight for bids in the lowest quintile, ⅖ probability weight for the bids in the next quintile, etc., where the highest quintile represents the highest bids for no more than one fifth of the shares).

In other embodiments where the earliest placed bids prevail, the successful bids may be determined by calculating the arithmetic mean of the bid prices based on the number of bids; a bid-weighted arithmetic median; dollar/shares bid weighted arithmetic mean; dollar/shares bid weighted arithmetic median; and the like. It is to be understood that in such embodiments, calculations may be rounded up or down to the nearest whole cent. For example, if two bids of $100,000 at $9.85 and two bids of $200,000 at $9.95 are presented, the bid weight mean would be $9.92 while the simple mean would be $9.90.

Successful bidders may also be selected in one round of bidding by repeating a selection pattern until all shares are allocated. For example, in one embodiment the process includes ordering the bids by time sequence first and then selecting winners by repeating a selection pattern until all shares are allocated where no bid placed prior to the last awarded shares can be selected. Any selection pattern may be used, including, for example, awarding the highest bid shares, then the lowest that occurred after that, then second-highest, then second lowest, then third highest, repeating the pattern until all shares are allocated.

Successful bidders may also be selected in one round of bidding by allocating shares to subgroups or classes of bidders in a tournament type selection. The bidders are first segregated into subgroups and then successful bids are determined within each subgroup. The subgroups are determined by any criteria, such as time frame of bid placement (e.g., all bids within X hours are in one group; all bids within the next Y minutes in a second subgroup, etc.). Similarly, any method, including, but not limited to, the discriminatory, uniform or random selection methods noted above, may be used to determine the winners.

Successful bidders may also be selected using multiple rounds of bidding. In one such embodiment, the sponsor/auctioneer names a price in the first round and bidders then indicate the quantity of shares they are willing to purchase at that price. The auctioneer then raises the price in a second round, and bidders again indicate the quantity of shares they are willing to purchase at that higher price. The auctioneer repeatedly raises the price (by either a fixed, e.g., 1 cent, or variable increment) in each subsequent round until a final price is reached. A final price may, but does not have to, be reached when there is no excess demand (or when all shares are allocated). The bidders in the final round receive the quantity of shares they indicated in that round. If the price is reached in a round with excess demand, then any other method, including, but not limited to, a random method or discriminatory method, can be used to allocate the shares among the bidders of that round.

Although the foregoing embodiments have been described in connection with bids that include a price per share, it is within the scope of the present invention to use other measures of amount to be paid by the bidders, including, for example, acceptable return. For example, in one embodiment bidders set forth their acceptable rate of return based on the redemption price of the shares; the lower the return bid, the more the bidder is willing to pay. As such, the processes for determining successful bids in the foregoing embodiments can be readily applied to embodiments in which the bids specify a rate of return, as opposed to a price per share.

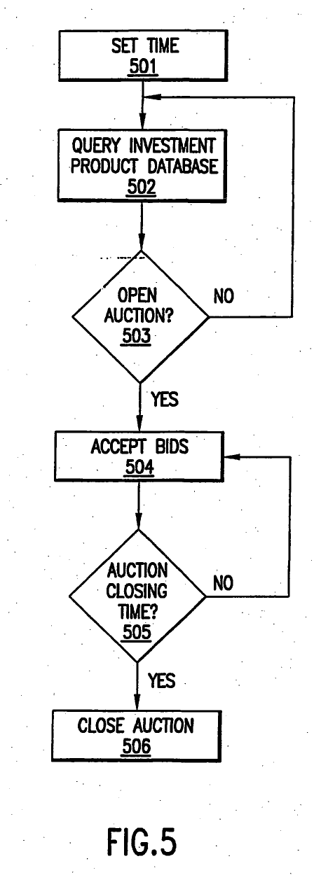

FIG. 5 is a flowchart showing the auction opening (step 420) and closing process (step 450) according to one embodiment of the present invention. In step 501, auction manager 336 maintains time in accordance with a timing component (not shown). In step 502, auction manager 336 continuously, periodically or a periodically queries the fund database 318 in order to determine whether any finds should be opened for auction. In step 503, auction manager 336 determines whether to open any auctions. If so, auction manager 336 opens the fund for auction, and allows bids to be submitted for that fund, step 504. As illustrated by steps 505 and 506, at the designated auction closing time, auction manager closes bidding on the auction. In one embodiment, auction manager 336 has more than one fund open for auction and conducts the auctions simultaneously.

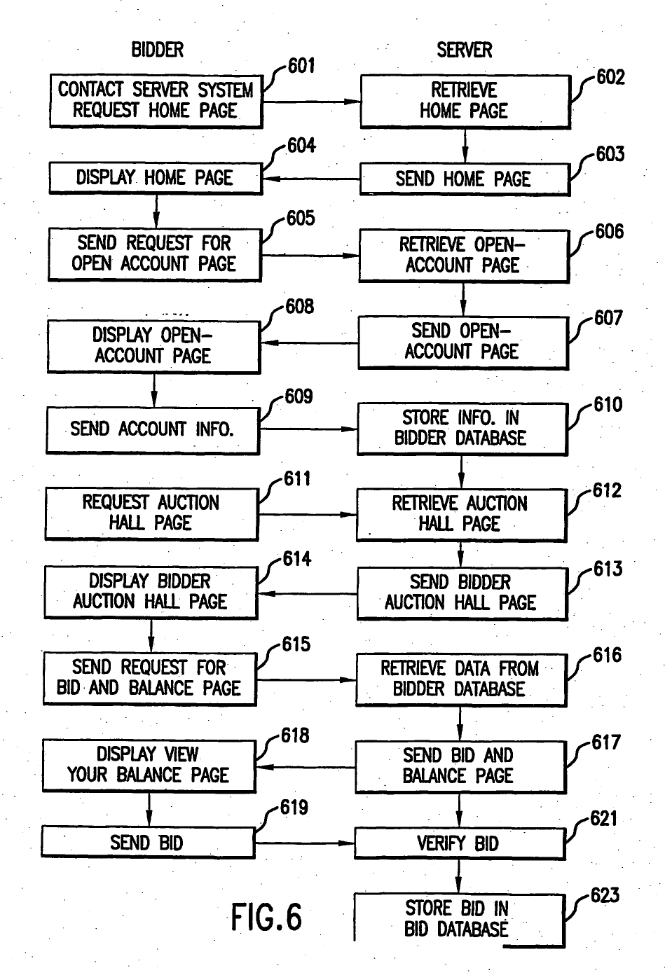

FIG. 6 is a flowchart showing an exemplary process for receiving (step 430) and storing bids (step 440). In step 601, bidder establishes contact with server system 110, preferably via the Internet. As illustrated by steps 602-604, in response, server system 110 retrieves and transmits for viewing on the bidder's computer the home page of the web site.

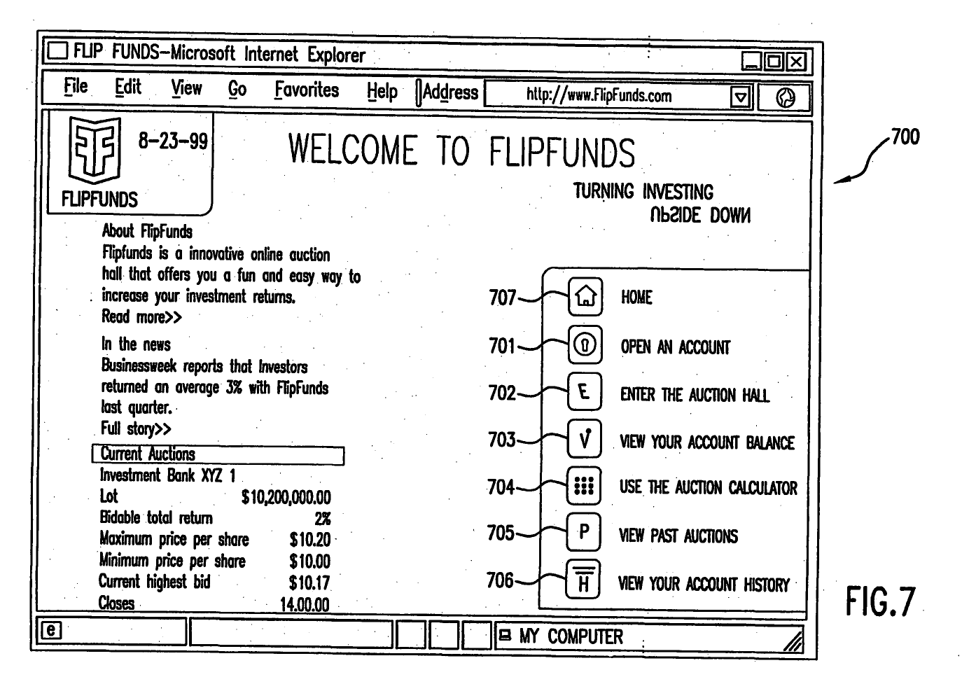

An illustrative web home page is shown in FIG. 7. At the home page, the bidder can select one of a plurality of hyperlinks 701-706 associated with the other pages of the web site.

If the bidder is new to the web site, he preferably selects hyperlink 701 to request a web page that will allow the bidder to open an account, step 605. As illustrated by steps 606-608, server system 110 then retrieves and transmits for display on the bidder's computer an open-account web page.

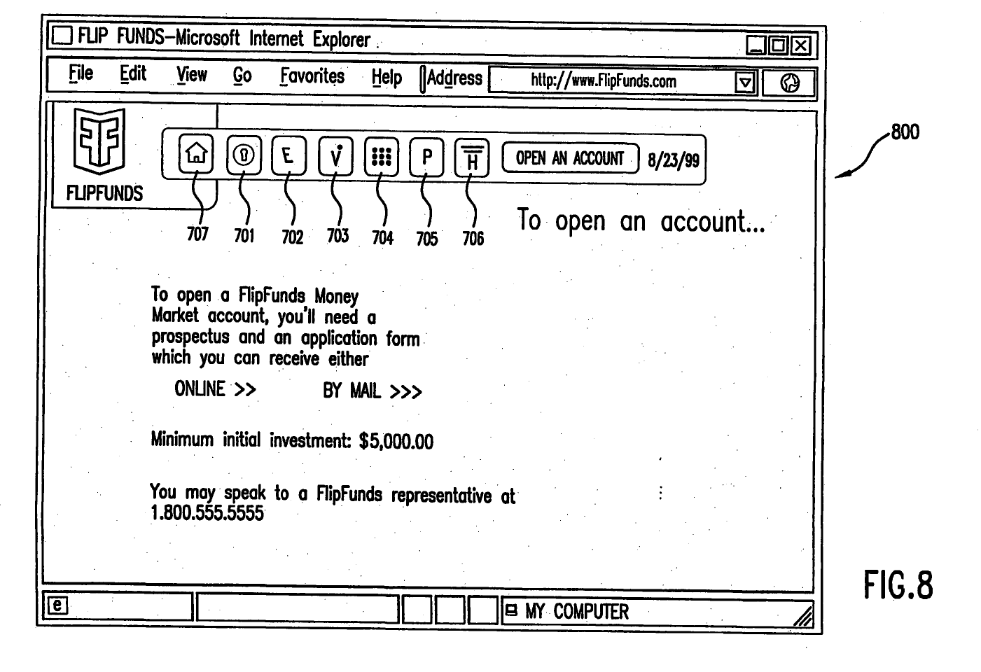

An illustrative web page that allows the bidder to open an account is shown in FIG. 8. At this web page 800, the bidder can establish an account, which serves as a settlement vehicle by placing a hold on the bidder's account for the amount of the bidder's bid multiplied by the number of shares bid. In a preferred embodiment, this account is a money market account in which amounts placed on hold continue to earn interest while the hold is in place.

In step 609, the bidder system 100 transmits the bidder's account information to server system 110. In step 610, server system 110 receives the bidder's account information and stores it in bidder database 328.

Once the bidder has established an account, the bidder may select a hyperlink to request (step 611) a web page showing auctions that are open for bidding. In other embodiments potential bidders that have not yet opened an account may view the auctions. As illustrated by steps 612-614, server system 110 then retrieves and transmits for display on the bidder's computer a web page providing the relevant auction information.

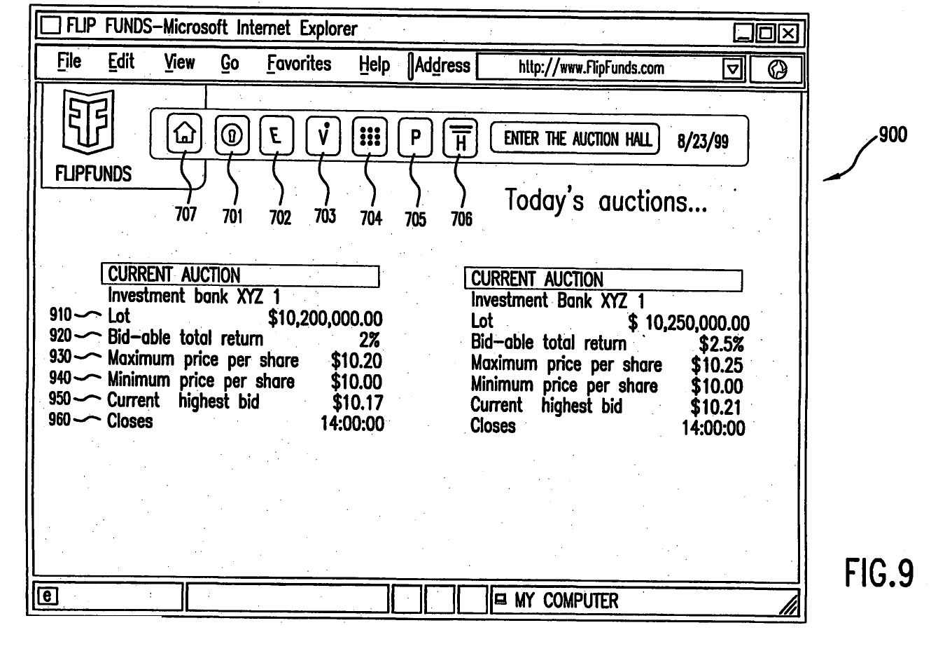

An illustrative web page showing auctions that are available to bid on is shown in FIG. 9. At this page 900, the bidder may view information about current and future auctions. In one embodiment, for each current auction, the page lists the total market value (910) and shares available (not shown) of the fund being auctioned, the total biddable return (920), the maximum price per share (930), the minimum price per share (940), the current highest bid (950), and the time (960) that the auction closes.

If the bidder wishes to participate in a current auction, bidder preferably selects hyperlink 703 to request (step 615) a web page that displays the bidder's account balance and which allows the bidder to submit a bid. In steps 616-618, server system 110 retrieves the account data and transmits for viewing on the bidder's computer a web page that allows the bidder to bid on the current auctions.

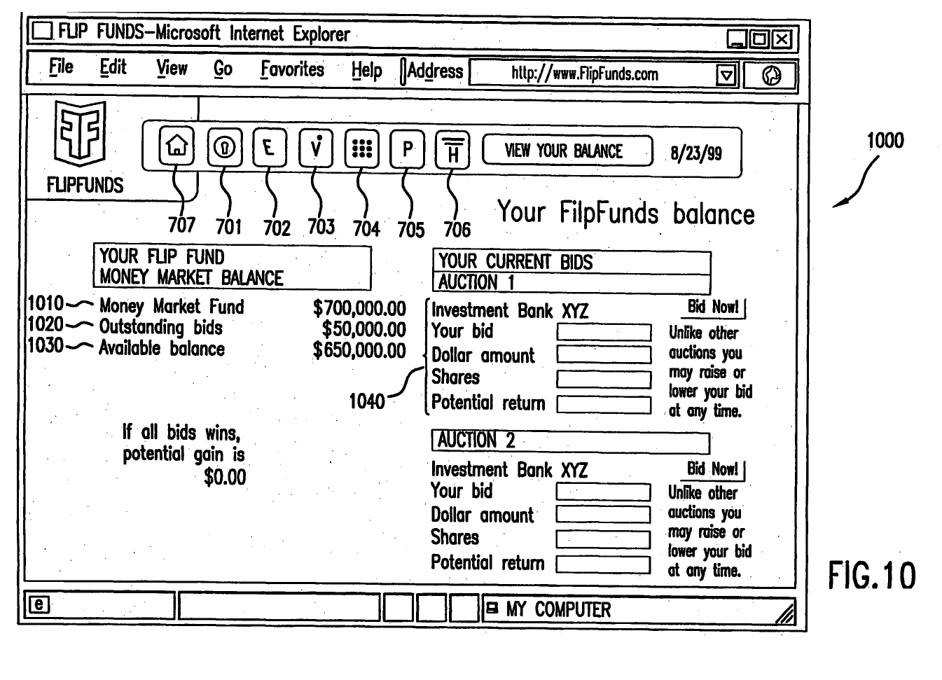

An illustrative web page allowing the bidder to bid on the auctions is shown in FIG. 10. At this web page 1000, the bidder is able to: view the balance 1010 of his account; view the value 1020 of his current outstanding bids; view his available balance 1030; and place bids 1040 in current auctions. In order to place a bid, the bidder preferably provides a bid for price per share and the number of shares bid.

In one embodiment, the bid must be within the maximum price per share (See 930 of FIG. 9) and the minimum share price per share (See 940 of FIG. 9) set by the fund. The fund sponsor thus controls the return it is willing to accept for use of its capital upon sale of the shares of the find in the auction.

Returning to FIG. 6, in step 619, the bidder transmits a bid to the server system 110. As illustrated by steps 621-623, the server system 110 receives the bid request and determines whether the bid is an acceptable bid.

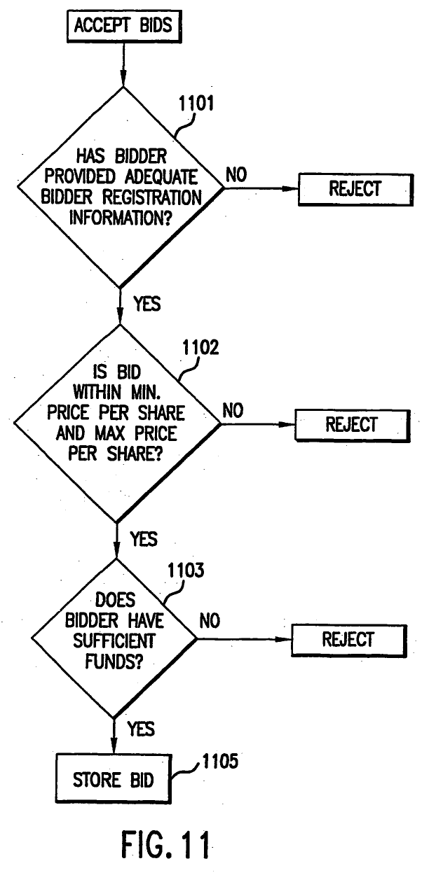

An illustrative process for verifying whether a particular bid is acceptable is shown in FIG. 11. As is illustrated, auction manager 336 first determines (step 1101) whether the bidder has provided adequate bidder registration information. Typically, this information includes, but is not limited to, the bidder's name, address, and tax identification information. Next, auction manager 336 determines (step 1102) whether the bid is within the minimum price per share and maximum price per share. Next, it determines (step 1103) whether the bidder has sufficient funds in his account to cover the bid by multiplying the bidder's bid price per share by the number of shares bid. If the bid fails any of these tests, the server preferably asks the bidder to change the bid as appropriate. On the other hand, if the bid is verified, the server system 110 then stores (step 623,1105) the bid information in open auction database 326 and bidder database 328. Preferably, server system 110 also places a “hold” on the bidder's account by reducing the bidder's available account balance in bidder database 328 by the amount of the bid (i.e., the bid price per share multiplied by the number of shares bid). In one embodiment, the holds remain in place until the next business day following the close of the auction period. In the case of successful bidders, the hold may exist until settlement of the transaction which may or may not coincide with the redemption of the shares at the redemption price.

As discussed above, in step 460, the server system 110 determines successful bidders according to one or more auction method formulas. In one embodiment, server system 110 successively determines the successful bidder. The successful bidder may correspond to the bidder with the highest bid price per share, or successful bidders may be determined according to other auction method formulas described above.

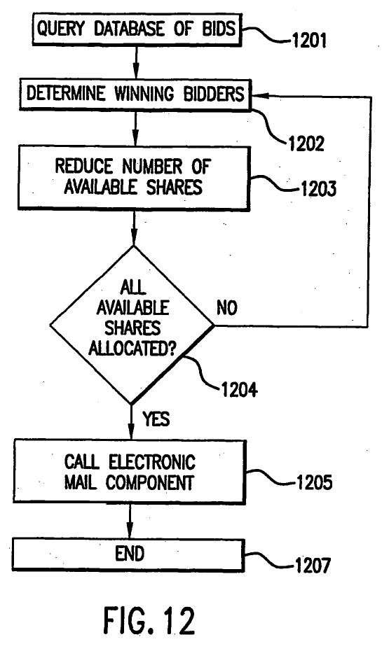

FIG. 12 depicts an illustrative process for determining the successful bidders according to a highest bidder auction formula. In step 1201, auction manager 336 queries open auction database 326 to determine all bids for the fund whose auction has just closed. In step 1202, auction manager 336 determines a successful bidder. The successful bidder is preferably the bidder who made the highest price-per-share bid. In step 1203, auction manager 336 reduces the number of shares available to be distributed to the successful bidder by the number of shares bid by the just-determined successful bidder.

In step 1204, auction manager 336 determines whether all of the available shares have been allocated. If not, auction manager 336 repeats steps 1201-1203 and successively determines the next successful bidder until all the available shares have been allocated. In step 1205, auction manager 336 calls electronic message component 232. Electronic message component 332 generates a message notifying the highest bidder that bid is a winning bid, and the message is sent to the bidder system. It should be noted that the server need not calculate all the successful bidders before calling the electronic message component to send e-mails to the successful bidders. Electronic message component 332 also transmits bidder registration information and successful bidders information to the fund's transfer agent for the purpose of settling the winning transactions.

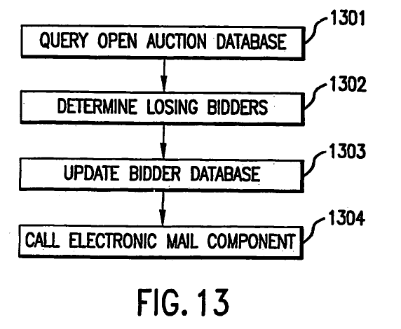

FIG. 13 is a flowchart showing an illustrative process for determining the unsuccessful bidders of a particular auction. In step 1301, auction manager 336 queries open auction database 326. In step 1302, auction manager 336 determines the losing bidders. In step 1303, server system 110 updates bidder database 328 by adding to the respective losing bidders' available balances their respective price per share bids multiplied by the number of shares bid thereby releasing the holds placed on the aforementioned money market accounts of those bidders. In step 1304, auction manager 336 calls electronic message component 332. Electronic message component 332 generates messages notifying the bidders that they have not won. Server system 110 then sends the messages to the unsuccessful bidders. Preferably server system 110 sends electronic messages to all losing bidders who participated in the auction.

The auction manager 336 also preferably keeps track of the number of successful bidders, the number of successful bids, the ratio of the total number of shares bid to the total number of shares available for auction, the ratio of successful bidders to bidders, and the average dollar bid. Preferably, server system 110 also updates past auction database 324 with past auction data in addition to the fund data obtained from fund database 318 on the fund auctioned.

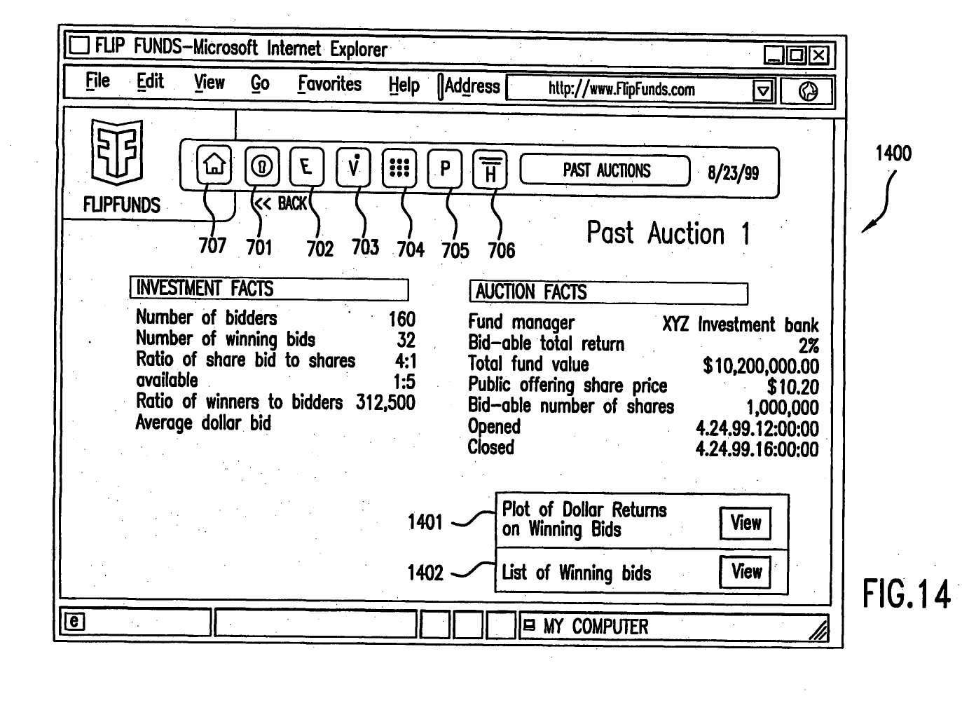

FIG. 14 is an illustrative web page showing information about a past auction. This page preferably displays the number of successful bidders, the number of successful bids, the ratio of the total number of shares bid to the total number of shares available for auction, the ratio of successful bidders to bidders, and the average dollar bid. At past auction page 1400, bidder can preferably select one of a plurality of hyperlinks 1401-1402 in order to view graphical or tabular data regarding past auctions.

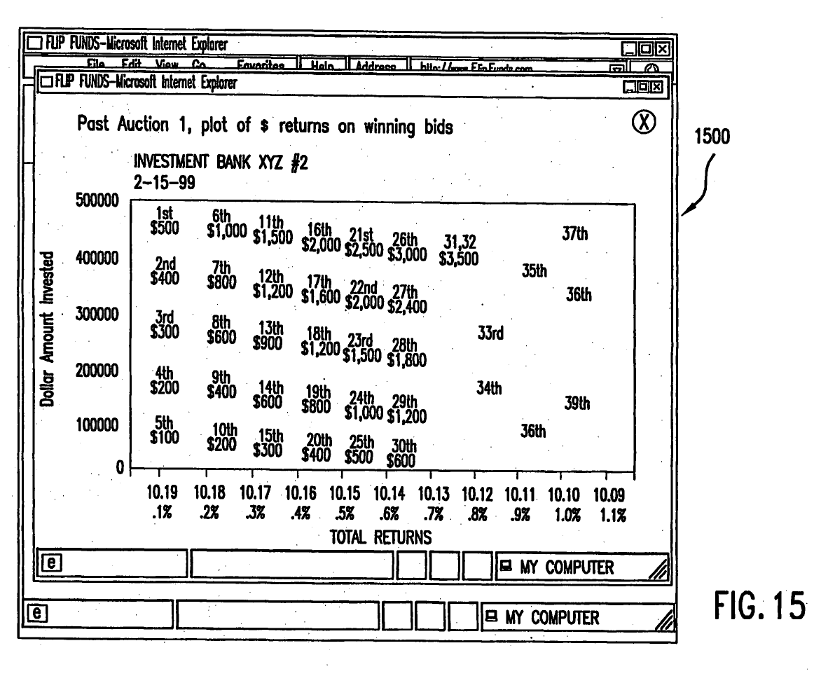

Preferably, if bidder selects hyperlink 1401, bidder is able to view a plot of dollar returns on successful bids. FIG. 15 depicts an illustration of a preferred dollar return on successful bids plot according to a highest bidder auction formula. In this example, the NAV of the shares of the fund is $10.20. Successful bidders bidding $10.19 earn a 0.1% rate of return. As such, successful bidders whose bids have a total dollar value of $500,000 earn a return of $500. This scenario is represented by plot point 1501.

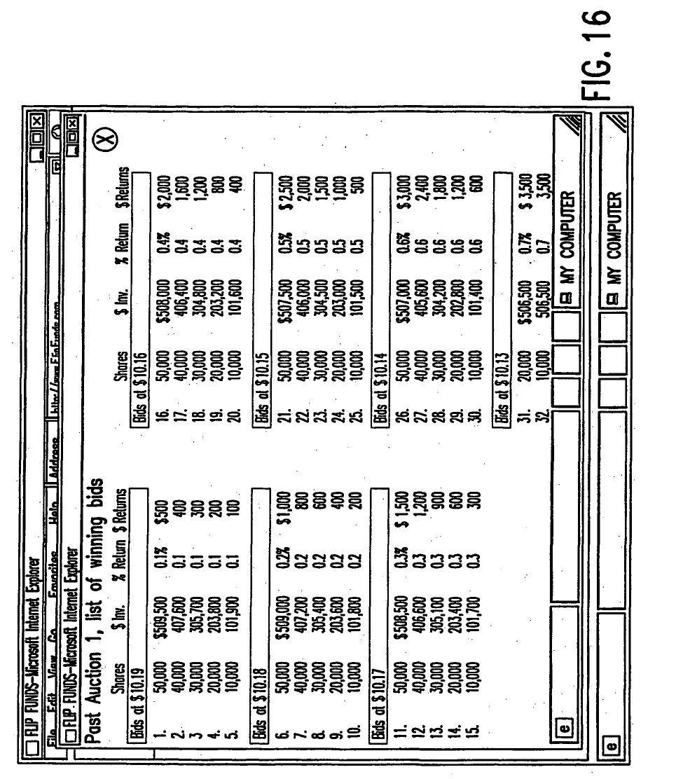

If bidder selects hyperlink 1402, bidder is able to view a list of successful bids. FIG. 16 depicts an illustrative list of successful bids according to a highest bidder auction formula. In this example, the NAV of the shares of the fund is $10.20. Successful bidders bidding $10.19 earn a 0.1% return. As such, successful bidders whose number of shares bid equals 50,000 and whose bids have total dollar value of $509,500 earn a return of $500. This scenario is represented by line 1601.

According to one alternate embodiment having a communications network having a server system and a plurality of bidder systems, a method of conducting an auction for shares of a fund that periodically declares a single NAV comprising:

a) receiving at the server system information relating to the fund, the fund having achieved a launch rate, the fund information including a total number of available shares and the NAV, the NAV corresponding to a share price of the fund at the launch rate;

b) storing at the server system the fund information;

c) opening an auction for the shares of the fund;

d) receiving from the bidder computers during the auction bids relating to the fund, the bids including a bid price per share and a number of shares bid;

e) storing the bids on the server system;

f) successively determining at the server system a successful bidders;

g) successively updating at the server system the fund information by reducing the number of available shares by the number bid by the successful bidders of shares until all of the available shares have been allocated.

The method may further comprise maintaining at the server system bidder account information corresponding to a bidder; and updating at the server system the bidder account information for each of the successful bidders to reflect a return, the return equaling the difference between the NAV and the respective successful bidders' bid price per share multiplied by the number of shares bid by each of the respective successful bidders.

The method may further comprise the successful bidder being the bidder who bid the highest bid price per share.

The method may further comprise storing on the server system open auction information.

The method may further comprise storing on the server system past auction information.

The method may further comprise generating graphical data based on the past auction information.

The method may further comprise generating tabular data based on the past auction information.

The method may further comprise generating graphical data based on the bidder account information.

The method may further comprise generating tabular data based on the bidder account information.

The method may further comprise generating electronic messages and transmitting electronic messages to the bidders.

The method may further comprise, as part of step (f),

generating an electronic message, the electronic message comprising bidder registration information and successful bidders information; and transmitting the electronic message to a transfer agent.

The method may further comprise receiving at the server system purchase information for each of the successful bidders, the purchase information relating to a purchase by each of the successful bidders of the number of shares bid by each of the respective successful bidders at the respective successful bidders's bid price per share.

According to another embodiment, in a communications network, a system for auctioning shares of a fund that declares a single NAV comprises:

a web site accessible via the communications network;

means for receiving information relating to the fund, the investment product having achieved a launch rate, the fund information including a total number of available shares and the NAV, the NAV corresponding to a share price of the fund at the launch rate;

means for storing the fund information;

means for opening an auction relating to the shares of the fund;

means for receiving bids from bidder computers during the auction, the bids including a bid price per share and the number of shares bid;

means for storing the bids;

means for successively determining a successful bidders; and

means for successively updating at the server system the fund information by reducing the number of available shares by the number bid by the successful bidders of shares until all of the available shares have been allocated.

The system may further comprise means for maintaining at the server system bidder account information corresponding to a bidder; and means for updating at the server system the bidder account information for each of the successful bidders to reflect a return, the return equaling the difference between the NAV and the respective successful bidders' bid price per share multiplied by the number of shares bid by each of the respective successful bidders.

The system may further comprise the successful bidder being a the bidder who bid the highest bid price per share.

The system may further comprise means for storing open auction information.

The system may further comprise means for storing past auction information.

The system may further comprise means for generating graphical data based on the past auction information.

The system may further comprise means for generating tabular data based on the past auction information.

The system may further comprise means for generating graphical data based on the bidder account information.

The system may further comprise means for generating tabular data based on the bidder account information.

The system may further comprise means for generating electronic messages and means for transmitting the electronic messages to the bidders.

The system may further comprise means for determining a successful bidders further including means for generating an electronic message, the electronic message comprising bidder registration information and successful bidders information; and means for transmitting the electronic messages comprising to a transfer agent.

The system may further comprise means for receiving at the server system purchase information for each of the successful bidders, the purchase information relating to a purchase by each of the successful bidders of the number of shares bid by each of the respective successful bidders at the respective successful bidders's bid price per share.

According to another embodiment, in a communications network having a server system and a plurality of bidder systems, a method of conducting an auction for shares of a fund that periodically declares a single NAV comprises:

a) receiving at the server system information relating to the fund, the fund having achieved a launch rate, the fund information including a total number of available shares, a redemption price per share, the redemption price per share corresponding to the share price of the fund at the launch rate, a maximum price per share, and a minimum price per share;

b) storing at the server system the fund information;

c) opening at the server an auction for the shares of the fund;

d) receiving from the bidder computers at the server system during the auction bids relating to the fund, the bids comprising a bid price per share and a number of shares bid, the bid price being greater than or equal to the minimum share price per share and less than or equal to the maximum share price per share;

e) storing the bids at the server system;

f) successively determining at the server system a successful bidders;

g) successively updating at the server system the fund information by reducing the number of available shares by the number bid by the successful bidders of shares until all of the available shares have been allocated.

The method may further comprise:

maintaining at the server system bidder account information corresponding to a bidder; and

updating at the server system the bidder account information for each of the successful bidders to reflect a return, the return equaling the difference between the redemption price per share and the respective successful bidders' bid price per share multiplied by the number of shares bid by each of the respective successful bidders.

Instill another embodiment, in a communications network having a server system and a plurality of bidder systems, a method of conducting an auction for shares of a fund that periodically declares a single NAV comprises:

a) receiving at the server system information relating to the fund, the fund having achieved a launch rate, the fund information including a total number of available shares and the NAV, the NAV corresponding to the share price of the fund at the launch rate;

b) storing at the server system the fund information;

c) opening an auction for the shares of the fund;

d) receiving from the bidder computers during the auction bids relating to the fund, the bids including a bid price per share and a number of shares bid;

e) placing a hold on the bidder's available balance for a total value of the bid, the total value of the bid based on the bid price per share and the number of shares bid;

f) successively determining at the server system a successful bidders; and

g) successively updating at the server system the fund information by reducing the number of available shares by the number bid by the successful bidders of shares until all of the available shares have been allocated.

The method may further comprise:

maintaining at the server system bidder account information corresponding to bidders, the bidder account information including available balances for each of the bidders; and updating at the server system the bidder account information for each of the successful bidders to reflect a return, the return equaling the difference between the current NAV and the respective successful bidders' bid price per share multiplied by the number of shares bid by each of the respective successful bidders.

While the present invention has been described with reference to certain embodiments, those skilled in the art will recognize that numerous variations and modifications may be made without departing from the scope of the present invention. This is especially true with regard to the presentation of information and configuration of web page displays and the manners of determining the winning bid, which may be varied greatly without departing from the scope of the present invention. Moreover, while a preferred embodiment regarding the system architecture of the present invention has been disclosed in connection with FIG. 1, in view of the foregoing description, other system architectures that can carry out one or more of the methods of the present invention may also be available, and all such other system architectures are contemplated to be within the scope of the present invention. For example, a system falling within the scope of this invention could employ a different configuration for the data storage, such as combining the databases, etc. In view of the foregoing, it should also be clear that only certain portions of the data preferably stored at server are necessary for carrying out the various methods of the present invention. (By way of example, the data preferably stored in past auction database is not utilized by the server when running a particular auction.) Moreover, as is well known in the art, the operation of the server could be divided among a number of computer devices. Accordingly, it should be clearly understood that the embodiments of the invention described above are not intended as limitations on the scope of the invention, which is defined only by the claims that are now or may later be presented.

What is claimed is:

1. A method of conducting an auction for shares of a fund comprising:
receiving information relating to the fund, said information including a total number of available shares and the net asset value, the net asset value corresponding to a share price of the fund at a launch rate;
receiving bids relating to the fund, the bids including a bid price per share and a number of shares bid; and
determining one or more winning bids.

2. The method of claim 1 further comprising:
maintaining at the server system bidder account information corresponding to a bidder; and
updating at the server system the bidder account information for each of the winning bidders to reflect a return, the return equaling the difference between the net asset value and the respective winning bidders' bid price per share multiplied by the number of shares bid by each of the respective winning bidders.

3. The method of claim 1 wherein the winning bidder is the bidder who bid the highest bid price per share.

4. The method of claim 1 further comprising storing on the server system open auction information.

5. The method of claim 1 further comprising storing on the server system past auction information.

6. The method of claim 5 further comprising generating graphical data based on the past auction information.

7. The method of claim 5 further comprising generating tabular data based on the past auction information.

8. The method of claim 1 further comprising generating graphical data based on the bidder account information.

9. The method of claim 2 further comprising generating tabular data based on the bidder account information.

10. The method of claim 1 further comprising generating electronic messages and transmitting electronic messages to the bidders.

11. The method of claim 1 further comprising:
generating an electronic message, the electronic message comprising bidder registration information and winning bidder information; and
transmitting the electronic message to a transfer agent.

12. The method of claim 1 further comprising:
receiving at the server system purchase information for each of the winning bidders, the purchase information relating to a purchase by each of the winning bidders of the number of shares bid by each of the respective winning bidders at the respective winning bidder's bid price per share.

13. In a communications network, a system for auctioning shares of a fund that declares a single net asset value comprising:
a web site accessible via the communications network;
means for receiving information relating to the fund, the investment product having achieved a launch rate, the fund information including a total number of available shares and the net asset value, the net asset value corresponding to a share price of the fund at the launch rate;
means for storing the fund information;
means for opening an auction relating to the shares of the fund;
means for receiving bids from bidder computers during the auction, the bids including a bid price per share and the number of shares bid;
means for storing the bids;
means for successively determining a winning bidder;
means for successively updating at the server system the fund information by reducing the number of available shares by the number bid by the winning bidder of shares until all of the available shares have been allocated.

14. The system of claim 13 further comprising:
means for maintaining at the server system bidder account information corresponding to a bidder; and
means for updating at the server system the bidder account information for each of the winning bidders to reflect a return, the return equaling the difference between the net asset value and the respective winning bidders' bid price per share multiplied by the number of shares bid by each of the respective winning bidders.

15. The system of claim 13 wherein the winning bidder is a the bidder who bid the highest bid price per share.

16. The system of claim 13 further comprising means for storing open auction information.

17. The system of claim 13 further comprising means for storing past auction information.

18. The system of claim 17 further comprising means for generating graphical data based on the past auction information.

19. The system of claim 17 further comprising means for generating tabular data based on the past auction information.

20. The system of claim 14 further comprising means for generating graphical data based on the bidder account information.

21. The system of claim 14 further comprising means for generating tabular data based on the bidder account information.

22. The system of claim 13 further comprising means for generating electronic messages and means for transmitting the electronic messages to the bidders.

23. The system of claim 13 wherein the means for determining a winning bidder further comprises:
means for generating an electronic messages the electronic message comprising bidder registration information and winning bidder information; and
means for transmitting the electronic messages comprising to a transfer agent.

24. The system of claim 13 further comprising:
means for receiving at the server system purchase information for each of the winning bidders, the purchase information relating to a purchase by each of the winning bidders of the number of shares bid by each of the respective winning bidders at the respective winning bidder's bid price per share.

25. In a communications network having a server system and a plurality of bidder systems, a method of conducting an auction for shares of a fund that periodically declares a single net asset value comprising:
receiving at the server system information relating to the fund, the fund having achieved a launch rate, the fund information including a total number of available shares, a redemption price per share, the redemption price per share corresponding to the share price of the fund at the launch rate, a maximum price per share, and a minimum price per share;
storing at the server system the fund information;
opening at the server an auction for the shares of the fund;
receiving from the bidder computers at the server system during the auction bids relating to the fund, the bids comprising a bid price per share and a number of shares bid, the bid price being greater than or equal to the minimum share price per share and less than or equal to the maximum share price per share;
storing the bids at the server system;
successively determining at the server system a winning bidder;
successively updating at the server system the fund information by reducing the number of available shares by the number bid by the winning bidder of shares until all of the available shares have been allocated.

26. The method of claim 25 further comprising:
maintaining at the server system bidder account information corresponding to a bidder; and
updating at the server system the bidder account information for each of the winning bidders to reflect a return, the return equaling the difference between the redemption price per share and the respective winning bidders' bid price per share multiplied by the number of shares bid by each of the respective winning bidders.

27. In a communications network having a server system and a plurality of bidder systems, a method of conducting an auction for shares of a fund that periodically declares a single net asset value comprising:
receiving at the server system information relating to the fund, the fund having achieved a launch rate, the fund information including a total number of available shares and the net asset value, the net asset value corresponding to the share price of the fund at the launch rate;
storing at the server system the fund information;
opening an auction for the shares of the fund;
receiving from the bidder computers during the auction bids relating to the fund, the bids including a bid price per share and a number of shares bid;
placing a hold on the bidder's available balance for a total value of the bid, the total value of the bid based on the bid price per share and the number of shares bid;
successively determining at the server system a winning bidder;
successively updating at the server system the fund information by reducing the number of available shares by the number bid by the winning bidder of shares until all of the available shares have been allocated.

28. The method of claim 27 further comprising:
maintaining at the server system bidder account information corresponding to bidders, the bidder account information including available balances for each of the bidders; and
updating at the server system the bidder account information for each of the winning bidders to reflect a return, the return equaling the difference between the current net asset value and the respective winning bidders' bid price per share multiplied by the number of shares bid by each of the respective winning bidders.
